(19) United States
(12) Patent Application Publication
(10) Pub. No.: US 2009/0252097 A1
(43) Pub. Date: Oct. 8, 2009

(54) BAND STEERING FOR MULTI-BAND WIRELESS CLIENTS

(75) Inventors: Pradeep J. Iyer, Cupertino, CA (US); Keerti G. Melkote, San Jose, CA (US); Partha Narasimhan, Santa Clara, CA (US)

Correspondence Address: BLAKELY SOKOLOFF TAYLOR & ZAFMAN LLP, 1279 OAKMEAD PARKWAY, SUNNYVALE, CA, 94085-4040, US

(73) Assignee: ARUBA NETWORKS, INC., Sunnyvale, CA (US)

(21) Appl. No.: 12/099,680

(22) Filed: Apr. 8, 2008

(51) Int. Cl. H04Q 7/00

(52) U.S. Cl. 370/329

(57) ABSTRACT

Band steering for multi-band wireless clients. In a wireless digital network having at least one central controller and a plurality of access nodes connected to the central controller, and wherein some of the access nodes support a preferred wireless band and at least one non-preferred wireless band, the central controller identifies wireless client devices capable of multi-band operation, and encourages them to connect to the preferred wireless band. Client devices may be identified as multi-band capable by tracking probe requests. The central controller keeps a list of multi-band capable clients, for example in a database. This information is provided to other central controllers, and to access nodes attached to the central controller. Multi-band capable clients are encouraged to connect on the preferred wireless band for example by having the access nodes not respond to probe requests on the non-preferred wireless bands. Connections made on the non-preferred wireless bands may be moved to the preferred wireless band.

### BACKGROUND OF THE INVENTION

The present invention relates to the operation of dual-band wireless digital networks, and to the process of assigning clients in dual-band networks.

Wireless digital networks, such as networks operating under IEEE 802.11 standards, are spreading in their popularity and availability. With such popularity, however, comes problems of resource availability and use. While a user of such networks may just think of them as “wireless,” those who plan and operate such networks usually have a deeper understanding. In many regulatory domains, such as the United States, channels are available for IEEE 802.11 wireless digital networks in both the 2.4 GHz and 5 GHz bands. More channels are available for use in the 5 GHz band, and therefore more capacity.

Many client devices are capable of operating on both 2.4 GHz and 5 GHz bands; many client devices are also limited to a single band, usually the older 2.4 GHz band.

What is needed are methods of “encouraging” dual-band capable clients to associate with channels in the “preferred” 5 GHz band where available, thus freeing up capacity in the “non-preferred” 2.4 GHz band for single-band clients.

### BRIEF DESCRIPTION OF THE DRAWINGS

The invention may be best understood by referring to the following description and accompanying drawings that are used to illustrate embodiments of the invention in which:

FIG. 1 shows a wireless network.

### DETAILED DESCRIPTION

Embodiments of the invention relate to band steering for multi-band Wi-Fi clients. In a wireless digital network having one or more central controllers operating a plurality of single and multi-band access nodes where one band is preferred, a central controller identifies multi-band capable clients, and encourages such multi-band clients to connect to the preferred band.

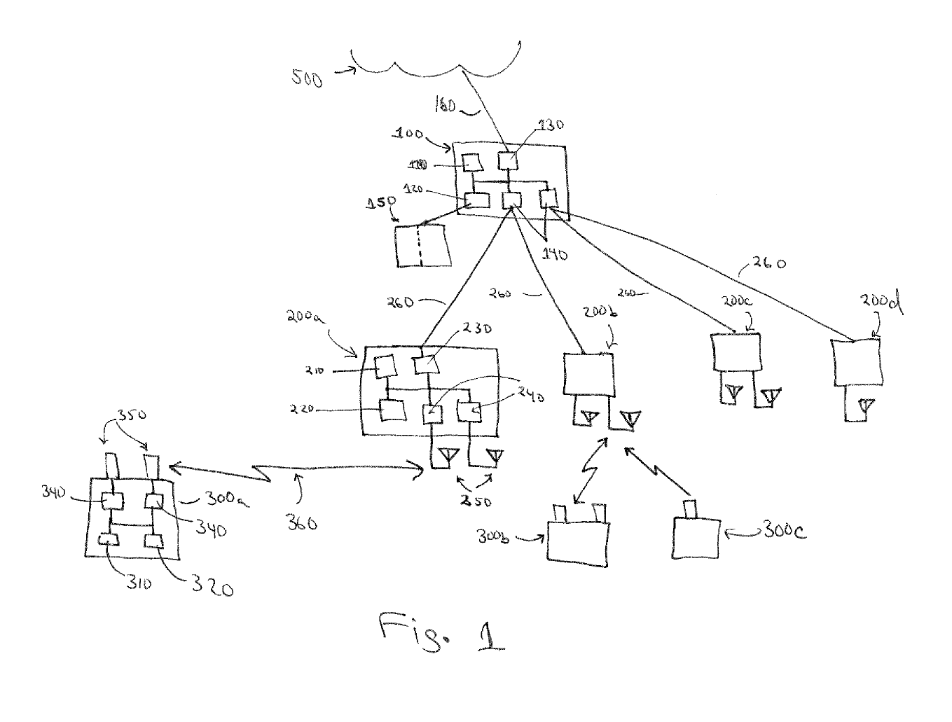

FIG. 1. shows an environment suitable for practicing the invention. Central controller 100 has central processing unit (CPU) 110 which connects to memory hierarchy 120, first network interface 130, and second network interfaces 140. Central controller 100 communicates 160 with network 500, which may contain other similar central controllers.

Central controller 100 connects 260 to access nodes 200a, 200b, 200c, 200d. Each access node 200 comprises a central processing unit 210 coupled to memory hierarchy 220, first network interface 230, and wireless network interfaces 240. Wireless network interfaces 240 are preferably wireless interfaces operating according to IEEE 802.11 standards, although other standards may be used, such as WiMAX. Where more than one wireless interface 240 is present in an access node, the different interfaces 240 operate using different frequency bands and antennas 250. As an example, an access node 200 may have as its first network interface an 802.3 wired Ethernet interface, and as its secondary network interfaces 240 a wireless IEEE 802.11 interface operating in the 2.4 GHz band, and a wireless IEEE 802.11 interface operating in the 5 GHz band. Other embodiments may contain, for example, wireless IEEE 802.11 interfaces, wireless interfaces for the 700 MHz band, and a wireless WiMAX interface.

According to the invention, one frequency band is considered the preferred band, and the other bands considered non-preferred. For the purposes of example, only two bands will be considered. In the case of IEEE 802.11 wireless networks, the 5 GHz band may be considered the preferred band and the 2.4 GHz band considered the non-preferred band. While this consideration may be made on the number of channels available, with more channels available on the 5 GHz band than on the 2.4 GHz band, the determination of which band is preferred among a group of bands may be made on other considerations as well. In some embodiments, this consideration may be based on coverage, on roaming characteristics, or on a desire to keep one band available for single-band only devices.

In central controller 100, CPU 110 is a MIPS-class CPU such as those from Cavium or Raza. CPUs from other manufacturers, such as Intel, AMD, ARM, or the like may also be used. Memory hierarchy 120 as understood by the art holds instructions and data necessary for practicing the invention on machine readable media and typically comprises a small amount of permanent storage for system initialization, fast read-write storage such as DRAM, and bulk storage such as hard disc or Compact Flash for storing files.

Similarly, with respect to access node 200, CPU 210 is a MIPS-class CPU such as those from Cavium or Raza. CPUs from other manufacturers, such as Intel, AMD, ARM, or the like may also be used. Memory hierarchy 220 as understood by the art holds instructions and data necessary for practicing the invention on machine readable media and typically comprises a small amount of permanent storage for system initialization, fast read-write storage such as DRAM, and bulk storage such as Compact Flash for storing files.

As understood by the art, the hardware platforms comprising central controller 100 and access nodes 200 may operate under control of target software running under a LINUX-variant operating system, or other operating system suitable for embedded devices.

Client devices 300a, 300b, 300c are also digital devices usually comprising CPU 310, memory hierarchy 320, displays, keyboards and the like, and one or more wireless interfaces 340 and antennas 350. Such client devices may range from small handheld units such as Wi-Fi phones having a single wireless interface such as for 2.4 GHz similar to 300c, or portable computers having wireless interfaces for both 2.4 GHz and 5 GHz, and possibly WiMAX.

According to an embodiment of the invention, a multi-band wireless network such as that shown in FIG. 1 has a plurality of access nodes connected to at least one central controller Many of these access nodes support operation on more than one frequency band, with one band being preferred for operation over other bands. As an example, for IEEE 802.11 Wi-Fi networks in many regulatory domains, more channels are available in the 5 GHz frequency band, the preferred band according to the invention, than in the 2.4 GHz frequency band, the non-preferred band. When serving multi-band capable clients, such multi-band clients are encouraged to use the preferred band, which also leaves the non-preferred band available for those single-band only clients.

In such a wireless network, it is desirable to uniquely identify client devices. As an example, in IEEE 802.11 networks, devices may be identified by their media access controller (MAC) address. In operation, central controller 100 identifies dual-band capable clients. When a client device is identified as multi-band capable, central controller 100 stores this information in database 150.

A client device 300 may be identified as multi-band capable in a number of ways. One way a client device 300 is identified as multi-band capable is recording when an access node 200 receives a probe request on the preferred band, such as the 5 GHz band.

A client device 300 may advertise its capabilities, such as the capability to operate on multiple bands, in probe requests as well. By observing such behavior, and other behaviors such as activity of devices on preferred and non-preferred bands, central controller 100 may further identify and record in database 150 which client devices 300 are multi-band capable.

According to an embodiment of the present invention, as client devices are identified as multi-band capable, this information is stored in a database 150 in central controller 100. Central controller 100 may store this information in a separate database denoting multi-band capability, or it may store this information as a field in an existing database kept by MAC address or other suitable unique client device identifier.

Central controller 100 shares the list of multi-band capable clients with other central controllers on network 500, and with access nodes 200 connected to central controller 100. This information may be pushed out by central controller 100, or it may be pulled out by access nodes 100 and other central controllers 100 on network 500. When a new access node 200 connects to central controller 100, the list of multi-band capable clients is sent to the new access node.

When a central controller receives information identifying a new client device as multi-band capable, it may push this information out to associated access nodes 200 immediately. Alternatively, central controller 100 may hold that information for periodic updates of access nodes 200, or hold the information until requested by access nodes 200.

In another embodiment of the invention, as client devices are identified as multi-band capable, and that information is sent by an access node 200 to central controller 100, central controller 100 resends this information to all access nodes 200, and any other central controllers 100 on network 500. In this manner, a central database is not kept on central controller 100, rather central controller 100 acts as a distribution point, supplying updates to access nodes 200 and other central controllers 100.

Once a client device 200 has been identified as multi-band capable by a central controller such as central controller 100, when client device 200 attempts to connect to an access node 300, it is encouraged to connect to the preferred band. Methods for accomplishing this include not responding to probe requests on the non-preferred band(s), denying association attempts on the non-preferred band(s), and accepting a client on the non-preferred band(s) but then moving such client to the preferred band using techniques such as 802.11v directed roaming, or by deauthentication and reauthentication.

As an example, if the 5 GHz band is the preferred band, and the 2.4 GHz band is the non-preferred band, when a client device 300 sends a probe request to an access node 200 on a non-preferred band, access node 200 checks its internal database to see if the client device has been identified as multi-band capable. If the client device has been identified as multi-band capable, then access node 200 ignores the probe request on the non-preferred band. When the client device sends a probe request in the preferred band, for example the 5 GHz band, that probe request receives a response, and the client device will connect on the preferred, in this example, 5 GHz band.

In an embodiment of the invention, central controller 100 commands attached access nodes 200 to scan clients in the background. Such a background scan may identify additional client devices as multi-band capable.

In an embodiment of the invention, when a client device which is connected to the non-preferred band, in this example the 2.4 GHz band, is identified as multi-band capable, the current connection between client device 300 and access node 200 may be maintained, with the client device moving to the preferred band when it next connects, or the client device may be moved from non-preferred to preferred band. In one embodiment, IEEE 802.11v directed roaming may be used. In another embodiment, central controller 100 sends a deauthentication message through the access node 200 to client device 300. When client device 300 reauthenticates, its probe requests to access node 200 will not receive responses, and so client device 300 will attempt to reauthenticate on the preferred band, in this example the 5 GHz band.

While the invention has been described in terms of various embodiments, the invention should not be limited to only those embodiments described, but can be practiced with modification and alteration within the spirit and scope of the appended claims. The description is this to be regarded as illustrative rather than limiting.

What is claimed is:

1. A method of associating wireless client devices to access nodes in a wireless digital network, wherein the access nodes connect to a central controller, and a plurality of the access nodes support operation on at least one non-preferred wireless band and on a preferred wireless band, the method comprising:
identifying wireless client capable of operating on the preferred wireless band,
maintaining by the central controller a list of wireless clients capable of operating on the preferred wireless band, and
encouraging wireless clients capable of operating on the preferred wireless band to connect on the preferred wireless band.

2. The method of claim 1 where the step of encouraging wireless clients capable of operating on the preferred wireless band to connect on the preferred wireless band comprises not responding to probe requests from wireless clients capable of operating on the preferred wireless band when those probe requests are received on a non-preferred wireless band.

3. The method of claim 1 where the step of encouraging wireless clients capable of operating on the preferred wireless band to connect on the preferred wireless band comprises only responding to probe requests from wireless clients capable of operating on the preferred wireless band when those probe requests are received on the preferred wireless band.

4. The method of claim 1 where the step of encouraging wireless clients capable of operating on the preferred wireless band to connect on the preferred wireless band comprises denying association requests on a non-preferred wireless band.

5. The method of claim 1 where the step of encouraging wireless clients capable of operating on the preferred wireless band to connect on the preferred wireless band comprises migrating connections made on a non-preferred wireless band by clients capable of operating on the preferred wireless band to connections on the preferred wireless band.

6. The method of claim 5 where the step of migrating connections made on a non-preferred wireless band by clients capable of operating on the preferred wireless band to connections on the preferred wireless band comprises deauthenticating the connection on the non-preferred wireless band followed by reauthenticating the connection on the preferred wireless band.

7. The method of claim 5 where the step of migrating connections made on a non-preferred wireless band by clients capable of operating on the preferred wireless band to connections on the preferred wireless band comprises migrating the connection using IEEE 802.11v directed roaming.

8. The method of claim 1 where the step of maintaining by the central controller a list of wireless clients capable of operating on the preferred wireless band comprises keeping a list at the central controller.

9. The method of claim 1 where the step of maintaining by the central controller a list of wireless clients capable of operating on the preferred wireless band comprises keeping a list of at least those access nodes capable of multi-band operation.

10. The method of claim 1 where the list of wireless clients capable of operating on the preferred wireless band is shared with the access nodes connected to the central controller.

11. The method of claim 10 where the step of sharing the list of wireless clients capable of operating on the preferred wireless band is shared with the access nodes connected to the central controller by the central controller pushing the list to the access nodes.

12. The method of claim 10 where the step of sharing the list of wireless clients capable of operating on the preferred wireless band is shared with the access nodes connected to the central controller by the access nodes requesting the list from the central controller.

13. The method of claim 1 where the list of wireless clients capable of operating on the preferred wireless band is shared with other central controllers.

14. A machine readable medium having a set of instructions stored therein, which when executed on a network system comprising a central controller connected to a plurality of access nodes, a plurality of those access nodes supporting operation on at least one non-preferred wireless band and on a preferred wireless band, cause a set of operations to be performed comprising:
identifying network clients capable of operating on the preferred wireless band
maintaining by the central controller a list of wireless clients capable of operating on the preferred wireless band, and
encouraging wireless clients capable of operating on the preferred wireless band to connect on the preferred wireless band with those access nodes which support the preferred wireless band.
